(19) United States
(12) Patent Application Publication
(10) Pub. No.: US 2026/0337017 A1
(43) Pub. Date: Oct. 29, 2026

(54) OXIDIZATION REACTOR FOR HYDROGEN FUEL CELL VEHICLE

(71) Applicant: Volvo Truck Corporation, Göteborg (SE)

(72) Inventor: Staffan LUNDGREN, Hindås (SE)

(21) Appl. No.: 19/114,494

(22) PCT Filed: Sep. 28, 2022
(86) PCT No.: PCT/IB2022/059242

§ 371 Date: Mar. 24, 2025

(51) Int. Cl. C01B 3/10; H01M 8/0606

(52) U.S. Cl. CPC C01B 3/10; H01M 8/0606; C01B 2203/066; H01M 2250/20

(57) ABSTRACT

A hydrogen (H2) storage system for a fuel cell electric vehicle includes a reaction volume for receiving a melted metal. The system further includes a metal storage container that stores the metal and transfers the metal to the reaction volume. The system further includes a heating element to heat the metal to a melting point of the metal to form the melted metal. The system further includes a steam inlet to introduce steam into the reaction volume to mix with the melted metal to form a metal oxide and H2, the steam formed by heating fuel cell exhaust water output by a hydrogen fuel cell (HFC) of the fuel cell electric vehicle. The system further includes an H2 outlet to output the H2 to an H2 storage container. The system further includes a metal oxide outlet to output the metal oxide to a metal oxide storage container.

### FIELD

Embodiments relate to hydrogen fuel cell (HFC) vehicles, and more particularly to an oxidization reactor for an HFC vehicle, and related systems, devices, and methods.

### BACKGROUND

Hydrogen fuel cell (HFC) vehicles and other types of vehicles may use stored pressurized hydrogen (H2) gas and/or liquid H2 as fuel for the HFC to generate electricity. Storage of pressurized H2 gas and/or liquid H2 onboard a vehicle has several drawbacks, however. For example, pressurized H2 gas has a low energy density per unit volume, i.e., about 6 MJ/L at 700 bar, and liquid H2 also has a relatively low energy density, i.e., about 10 MJ/L. Accordingly, as the desired range of HFC vehicles increases, larger and larger storage containers are required, which can impact the overall storage capacity and utility of the vehicle. Thus, there is a need for a hydrogen storage system for an HFC vehicle with improved energy density and efficiency.

### SUMMARY

According to some embodiments, a hydrogen (H2) storage system for a fuel cell electric vehicle includes a reaction volume for receiving a melted metal. The system further includes a metal storage container to store a metal, the metal storage container arranged to transfer the metal to the reaction volume. The system further includes a heating element to heat the metal to a melting point of the metal to form the melted metal. The system further includes a steam inlet to introduce steam into the reaction volume to mix with the melted metal to form a metal oxide and H2, the steam formed by heating fuel cell exhaust water output by a hydrogen fuel cell (HFC) of the fuel cell electric vehicle. The system further includes an H2 outlet to output the H2 to an H2 storage container. The system further includes a metal oxide outlet to output the metal oxide to a metal oxide storage container. According to some embodiments, a hydrogen (H2) storage system includes an H2 storage container.

The system further includes a hydrogen fuel cell (HFC) for receiving H2 from the H2 storage container and outputting exhaust water. The system further includes a metal storage container to store a metal powder. The system further includes a first heating element to heat the exhaust water to form steam. The system further includes a second heating element to heat the metal powder to form a melted metal. The system further includes a reactor including a reaction volume. The reactor further includes a melted metal inlet to receive the melted metal into the reaction volume. The reactor further includes a steam inlet to receive the steam into the reaction volume, such that the melted metal and the steam mix to form a metal oxide and H2. The reactor further includes an H2 outlet to output the H2 from the reaction volume to the H2 storage container.

According to some embodiments, a method includes transferring a metal powder from a metal storage container through a heating volume to form a melted metal. The method further includes transferring the melted metal into a reaction volume of a reactor of a fuel cell electric vehicle. The method further includes forming steam from fuel cell exhaust water output by a hydrogen fuel cell (HFC) of the fuel cell electric vehicle. The method further includes transferring the steam into the reaction volume to mix with the melted metal to form a metal oxide and H2. The method further includes outputting the H2 to an H2 storage container. The method further includes outputting the metal oxide to a metal oxide storage container.

### ASPECTS

According to an aspect, a hydrogen (H2) storage system for a fuel cell electric vehicle includes a reaction volume for receiving a melted metal. The system further includes a metal storage container to store a metal, the metal storage container arranged to transfer the metal to the reaction volume. The system further includes a heating element to heat the metal to a melting point of the metal to form the melted metal. The system further includes a steam inlet to introduce steam into the reaction volume to mix with the melted metal to form a metal oxide and H2, the steam formed by heating fuel cell exhaust water output by a hydrogen fuel cell (HFC) of the fuel cell electric vehicle. The system further includes an H2 outlet to output the H2 to an H2 storage container. The system further includes a metal oxide outlet to output the metal oxide to a metal oxide storage container.

According to another aspect, the metal is a metal powder, and the heating element is arranged to heat the metal powder during transfer of the metal powder from the metal storage container into the reaction volume.

According to another aspect, the heating element is a resistive heating element.

According to another aspect, the metal storage container further stores a pressurized gas at a storage pressure higher than a working pressure of the reaction volume to facilitate transfer of the metal powder toward the reaction volume.

According to another aspect, the pressurized gas is not reactive with respect to the metal powder.

According to another aspect, the metal storage container is replaceable.

According to another aspect, the metal oxide storage container is replaceable.

According to another aspect, the melted metal is at least one of aluminum, iron, and borium.

According to another aspect, the system further includes a water storage container to receive the fuel cell exhaust water from the HFC and output the fuel cell exhaust water toward the steam inlet.

According to another aspect, the system further includes a heating element disposed between the water storage container and the steam inlet to heat the fuel cell exhaust water to form the steam.

According to another aspect, the heating element is a resistive heating element.

According to another aspect, the H2 storage container is adapted to provide the H2 to the HFC.

According to an aspect, a hydrogen (H2) storage system includes an H2 storage container. The system further includes a hydrogen fuel cell (HFC) for receiving H2 from the H2 storage container and outputting exhaust water. The system further includes a metal storage container to store a metal powder. The system further includes a first heating element to heat the exhaust water to form steam. The system further includes a second heating element to heat the metal powder to form a melted metal. The system further includes a reactor including a reaction volume. The reactor further includes a melted metal inlet to receive the melted metal into the reaction volume. The reactor further includes a steam inlet to receive the steam into the reaction volume, such that the melted metal and the steam mix to form a metal oxide and H2. The reactor further includes an H2 outlet to output the H2 from the reaction volume to the H2 storage container.

According to another aspect, the metal storage container further stores a pressurized gas at a storage pressure higher than a working pressure of the reaction volume to facilitate transfer of the metal powder from the metal storage container to the reaction volume, wherein the first heating element is arranged to heat the metal powder during the transfer of the metal powder from the metal storage container into the reaction volume.

According to another aspect, the metal storage container is replaceable.

According to another aspect, the system further includes a metal oxide storage container, wherein the reactor further comprises a metal oxide outlet to output the metal oxide from the reaction volume to the metal oxide storage container.

According to another aspect, the metal oxide storage container is replaceable.

According to an aspect, a method includes transferring a metal powder from a metal storage container through a heating volume to form a melted metal.

The method further includes transferring the melted metal into a reaction volume of a reactor of a fuel cell electric vehicle. The method further includes forming steam from fuel cell exhaust water output by a hydrogen fuel cell (HFC) of the fuel cell electric vehicle. The method further includes transferring the steam into the reaction volume to mix with the melted metal to form a metal oxide and H2. The method further includes outputting the H2 to an H2 storage container. The method further includes outputting the metal oxide to a metal oxide storage container.

According to another aspect, the metal storage container is replaceable, and the metal oxide storage container is replaceable.

According to another aspect, the metal powder is at least one of aluminum, iron, and borium.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a diagram of a hydrogen fuel cell (HFC) energy storage system including an oxidization reactor to form hydrogen (H2) from exhaust water and a metal reactant, according to some embodiments;

FIG. 2 illustrates a diagram of an HFC energy storage system including a replaceable metal powder cartridge for introducing the metal reactant into the oxidization reactor, according to some embodiments;

FIG. 3 illustrates graph of energy densities of various materials per unit volume and per unit weight, according to some embodiments; and

FIG. 4 is a flowchart of operations for operating a HFC energy storage system, according to some embodiments.

### DETAILED DESCRIPTION OF EMBODIMENTS

Embodiments relate to hydrogen fuel cell (HFC) vehicles, and more particularly to an oxidization reactor for an HFC vehicle, and related systems, devices, and methods.

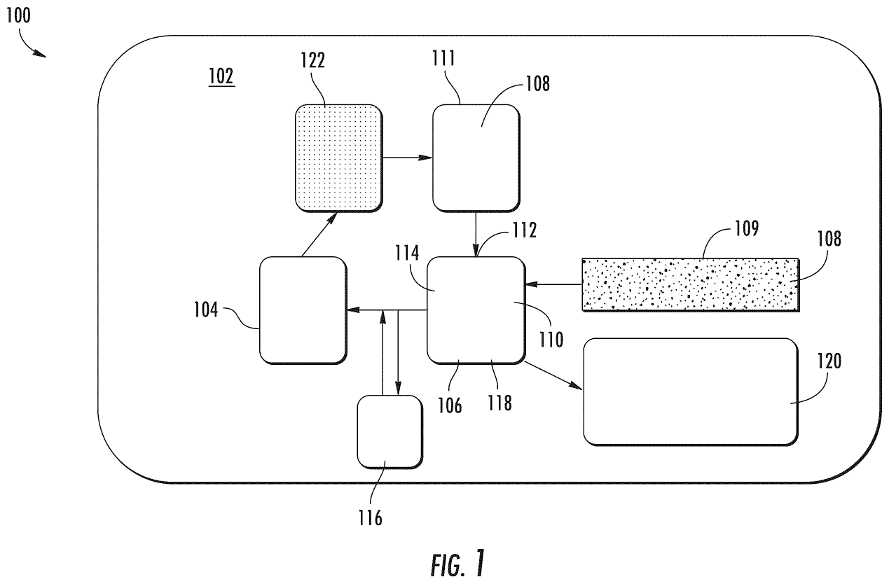

In this regard, FIG. 1 illustrates a diagram of a hydrogen fuel cell (HFC) storage system 100 including an oxidization reactor 105 to form hydrogen (H2) from exhaust water and a metal reactant, according to some embodiments. In this example, the system 100 is part of a fuel cell electric vehicle 102 employing HFCs 104 to generate electricity from the generated and/or stored H2, but it should be understood that the storage system 100 of this and other embodiments may be adapted for use in a wide variety of applications.

The reactor 105 includes a reaction volume 106 for receiving a melted metal 108. The metal 108 is stored in a metal storage container 109, which is arranged to transfer the metal 108 to the reaction volume 106 via a metal inlet 110. Steam is also introduced into the reaction volume 106 via a steam inlet 112. The steam in this embodiment is provided by exhaust water output by the HFC 104. For example, the exhaust water is filtered through a zeolite filter 122, is stored in a water storage container 111, and is then heated to form the steam.

The steam mixes with the melted metal 108 to form a metal oxide and H2 gas. The H2 gas is output to an H2 storage container 116 via an H2 outlet 113, and the H2 storage container 116 is adapted to provide the H2 to the HFC 104. Alternatively, or in addition the H2 gas may be provided directly to the HFC 104 from the H2 outlet 113 in some embodiments. The metal oxide is output to a metal oxide storage container 120 via a metal oxide outlet 119.

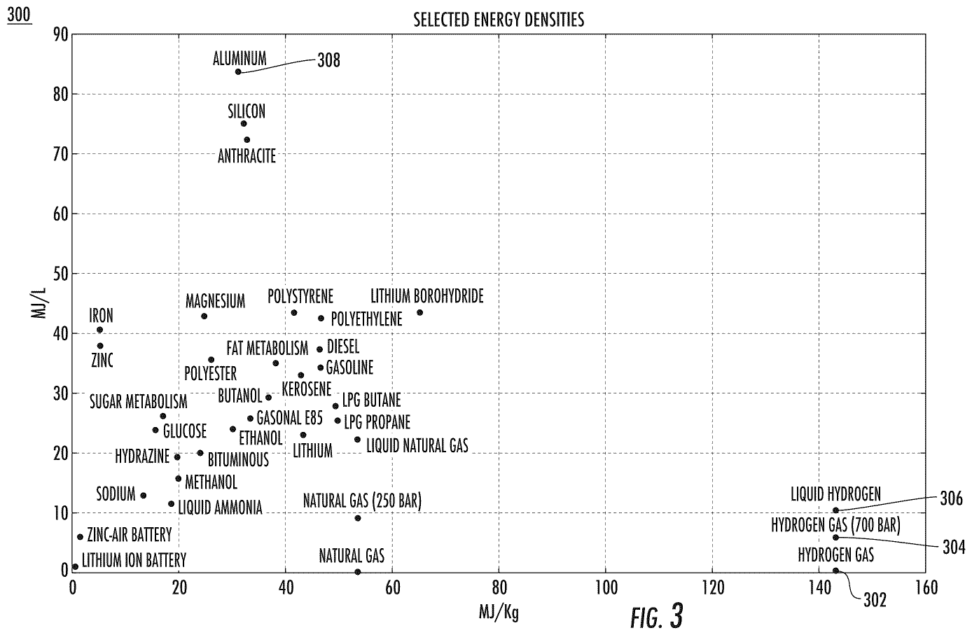

In this embodiment, the metal storage container 109 is replaceable. For example, the metal storage container 109 may be filled with the metal 108 at a central location, such as a recycling facility. The metal 108 in this embodiment is aluminum, but other metals may be used as well, such as iron and/or borium, for example. As will be discussed below with respect to FIG. 3, Aluminum has a very high energy density per unit volume compared to H2 gas and/or liquid H2 for example. After the metal 108 is delivered to the reaction volume 106 and used to generate H2, the empty metal storage container 109 can be removed and returned to the recycling facility to be refilled and reused.

The metal oxide storage container 120 is also replaceable in this embodiment. After the metal oxide storage container 120 is filled with the metal oxide, the metal oxide storage container 120 may be removed and sent to the recycling facility or other facility, where the metal oxide storage container 120 is emptied and the metal oxide is reused, e.g., converted back to the metal for refilling the metal storage containers 109. For example, in some embodiments, the metal oxide, e.g., aluminum oxide, may be combined with H2 to deoxidize the aluminum, which can then be powdered and used to refill empty metal storage containers 109.

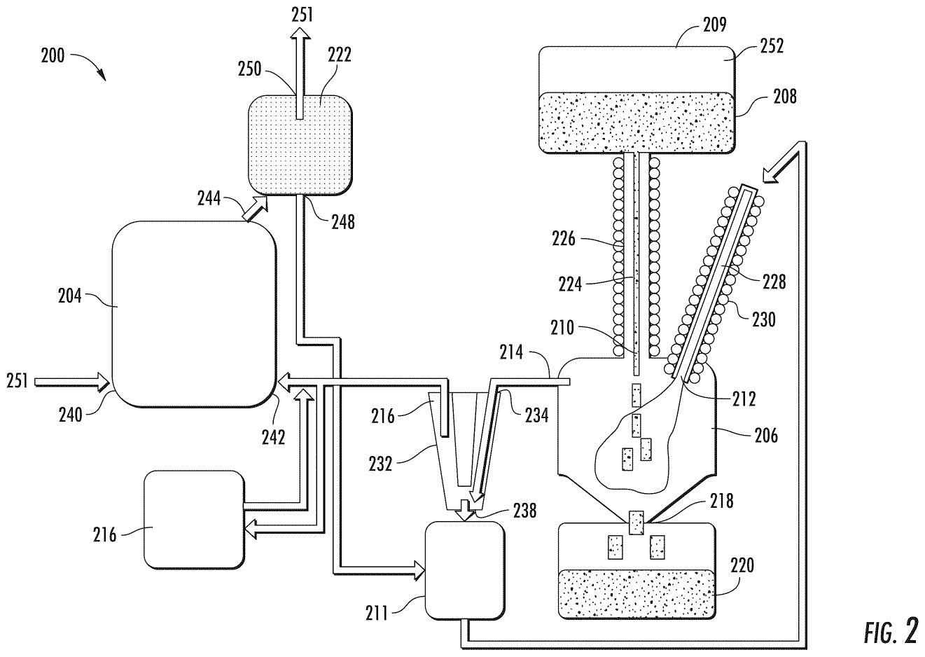

FIG. 2 illustrates a diagram of an HFC storage system 200 including a replaceable metal powder cartridge 209 for introducing the metal 208 reactant into the oxidization reactor 205, according to some embodiments. Similar to the system 100 of FIG. 1, the reactor 205 of FIG. 2 includes a reaction volume 206 for receiving the melted metal 208. The cartridge 209 is filled with a powdered from of the metal 208, e.g., aluminum powder, and a non-reactive gas 252, e.g., H2. In this example, the gas 252 is pressurized to maintains a storage pressure of the metal 208 that is higher than a working pressure of the reaction volume 206, such that the pressurized gas 252 urges the metal 208 through a metal heating passage 224 extending between the cartridge 209 and the metal inlet 210, to facilitate transfer of the metal 208 toward the reaction volume 206. In other examples, the gas 252 may not be pressurized, and may allow the metal 208 to pass into the metal heating passage 224 by gravity alone, e.g., by positioning the cartridge 209 directly above the metal heating passage 224 and the reaction volume 206. One benefit of maintaining the gas 252 at a higher pressure is to urge the metal 208 through the metal heating passage 224 and into the reaction volume 206 before significant melting and/or oxidization occurs. If the working pressure of the reaction volume 206 is higher than the pressure of the gas 252, equalization of the pressure between the reaction volume 206 and the gas 252 may allow ingress of heated gas from the reaction volume 206 into the cartridge 209 in some configurations, which may result in the metal 208 prematurely melting and/or oxidizing within the cartridge 209 rather than the reaction volume 206, which may decrease efficiency, damage components, and/or increase fire risk.

A metal heating element 226, e.g., a resistive heating coil, heats the metal 208 to its melting point during transfer of the metal 208 through the metal heating passage 224 so that the metal 208 is provided into the reaction volume 206 in a molten form, thereby allowing the metal 208 to react with the steam more efficiently. It should be understood that the metal 208 may be provided and/or stored in other forms as well. For example, the metal 208 may be supplied in as a band and/or rod, with individual portions being separated and melted individually, or with a distal end of the metal 208 being continuously melted by the metal heating passage 224 and fed into the reaction volume 208.

The fuel cell exhaust water is passed from the water storage container 211 through a water heating passage 228, where it is similarly heated by a water heating element 230, e.g., another resistive coil, to form the steam and provide the steam to the steam inlet 212. As with FIG. 1, the exhaust water may also filtered through a zeolite filter 222. For example, the exhaust water may be introduced into the zeolite filter 222 through a zeolite water inlet 246 to remove air and other contaminants. The filtered exhaust water is provided to the water storage container 211 through a zeolite water outlet 248 and the air may be expelled through a zeolite air outlet 250 to an exhaust system and/or into the atmosphere 251, for example.

As with FIG. 1, the metal oxide is output to the metal oxide storage container 220 via the metal oxide outlet 218, and the H2 formed by the reaction of the metal 208 and the steam is provided to the H2 storage container 216 via the H2 outlet 214. In this example, the H2 also passes through a water trap 232, which aids in separating excess water vapor from the H2. For example, the H2 and excess water vapor is introduced into the water trap via a water trap inlet 234 so that the H2 and water vapor cools sufficient to cause condensation. The condensed water collects in the water trap 232 and is removed via a water trap water outlet 238, where it may be returned to the water storage container 111 and/or ejected into the environment for example.

The remaining H2 gas is output to the H2 storage container 216 and/or to the HFC 204 via a water trap H2 outlet 236. The HFC 204 in this embodiment receives air from the atmosphere 251 via an HFC air inlet 240 and the H2 via an HFC H2 inlet 242 to generate electricity, with the exhaust water and air being output to the zeolite filter 222 and/or water storage container 211 via an HFC exhaust outlet 244.

FIG. 3 illustrates graph 300 of energy densities of various materials by unit volume and by unit weight, according to some embodiments. As noted above, H2 has a relatively high energy density by weight, i.e., approximately 145 MJ/kg, but has a low energy density by volume, which limits the amount of H2 that can be stored onboard vehicles and other volume-limited applications. For example, H2 gas 302 at atmospheric pressure has an energy density of approximately 1 MJ/L by volume. Pressurized H2 gas 304 has a somewhat higher energy density of approximately 6 MJ/L at 700 bar, while liquid H2 306 has an energy density of about 10 MJ/L.

In contrast, many reactive metals have significantly higher energy densities by volume. For example, as shown by FIG. 3, aluminum 308 has an energy density of about 84 MJ/L, thereby allowing vehicles and other volume limited applications to store a significantly larger amount of energy onboard without refueling. While the energy density by weight of aluminum and other metals is comparatively lower than H2 gas and/or liquid H2, the higher weight of the fuel may be more manageable in many vehicle applications and other applications and the benefits from volume savings in such applications may outweigh any drawbacks due to the comparatively higher weight of the fuel. For example storing 10,000 MJ of energy on a vehicle would require 1,000 liters of liquid H2 306, weighing approximately 69 kg, or 118 L of Aluminum 308, weighing approximately 333 kg. In many commercial vehicle applications the higher weight of the Alumunum fuel may be preferable to significantly higher volume requirements of the liquid H2 fuel.

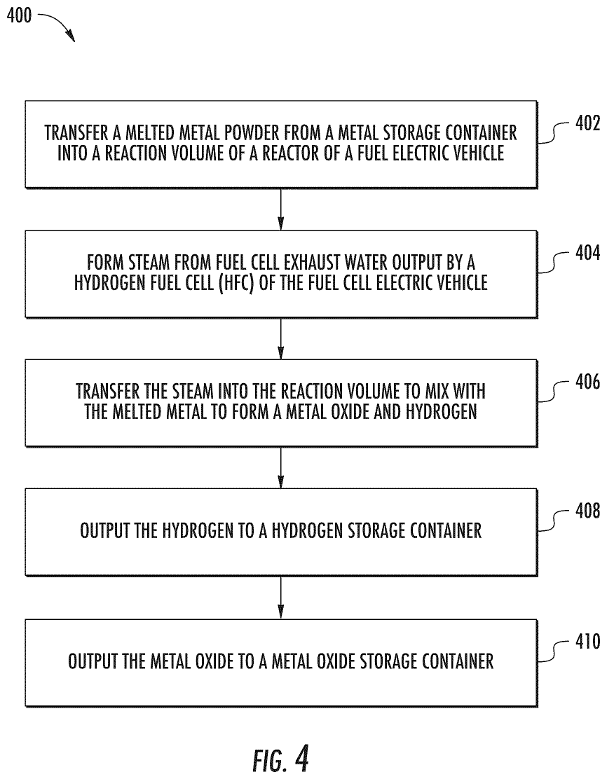

FIG. 4 is a flowchart of operations 400 for operating a HFC storage system, according to some embodiments. The operations 400 may include transferring a metal powder from a metal storage container through a heating volume to form a melted metal (Block 402). For example, in the example of FIG. 2 above, metal powder 208 is transferred from a cartridge 209 through metal heating passage 226, which heats the metal 208 to its melting point.

The operations 400 may further include transferring the melted metal into a reaction volume of a reactor of a fuel cell electric vehicle (Block 404) Referring again to the example of FIG. 2, the melted metal 208 is transferred from the metal heating passage 224 to the reaction volume 206 of reactor 205 via a metal inlet 210.

The operations 400 may further include forming steam from fuel cell exhaust water output by a hydrogen fuel cell (HFC) of the fuel cell electric vehicle (Block 406). For example, as shown by FIG. 2, exhaust water may be transferred from a water storage container 211 through a water heating passage 228 to form the steam.

The operations 400 may further include transferring the steam into the reaction volume to mix with the melted metal to form a metal oxide and H2 (Block 408). As shown by FIG. 2, the steam is transferred from the water heating passage 228 to the to the reaction volume 206 of reactor 205 via a steam inlet 212. The steam mixes with the melted metal 208 to form H2 and the metal oxide.

The operations 400 may further include outputting the H2 to an H2 storage container (Block 410). In the embodiment of FIG. 2, for example, the H2 is output to the H2 storage container 216 via an H2 outlet 214 of the reactor 205.

The operations 400 may further include outputting the metal oxide to a metal oxide storage container (Block 412). In the embodiment of FIG. 2, the metal oxide is output to metal oxide storage container 220 via the metal oxide outlet 218 of the reactor 205.

These and other embodiments address the technical limitations of conventional passive, gravity-based degassing systems by permitting a degassing system to be positioned in different parts of the cooling system. Unlike conventional degassing systems that are positioned at the highest point of the cooling system, embodiments of the present disclosure allow functional pressure equalization systems to be positioned below the radiators and other components of the cooling system, as desired. This allows for greater flexibility and efficiency in the design of cooling systems for vehicles and other applications.

When an element is referred to as being “connected”, “coupled”, “responsive”, “mounted”, or variants thereof to another element, it can be directly connected, coupled, responsive, or mounted to the other element or intervening elements may be present. In contrast, when an element is referred to as being “directly connected”, “directly coupled”, “directly responsive”, “directly mounted” or variants thereof to another element, there are no intervening elements present. Like numbers refer to like elements throughout. As used herein, the singular forms “a”, “an” and “the” are intended to include the plural forms as well, unless the context clearly indicates otherwise. Well-known functions or constructions may not be described in detail for brevity and/or clarity. The term “and/or” and its abbreviation “/” include any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but do not preclude the presence or addition of one or more other features, integers, elements, steps, components, functions or groups thereof.

Furthermore, as used herein, the common abbreviation “e.g.,”, which derives from the Latin phrase “exempli gratia,” may be used to introduce or specify a general example or examples of a previously mentioned item, and is not intended to be limiting of such item. The common abbreviation “i.e.,”, which derives from the Latin phrase “id est,” may be used to specify a particular item from a more general recitation.

Persons skilled in the art will recognize that certain elements of the above-described embodiments may variously be combined or eliminated to create further embodiments, and such further embodiments fall within the scope and teachings of inventive concepts. It will also be apparent to those of ordinary skill in the art that the above-described embodiments may be combined in whole or in part to create additional embodiments within the scope and teachings of inventive concepts. Thus, although specific embodiments of, and examples for, inventive concepts are described herein for illustrative purposes, various equivalent modifications are possible within the scope of inventive concepts, as those skilled in the relevant art will recognize. Accordingly, the scope of inventive concepts is determined from the appended claims and equivalents thereof.

1. A hydrogen (H2) storage system for a fuel cell electric vehicle, comprising:
a reaction volume for receiving a melted metal;
a metal storage container to store a metal, the metal storage container arranged to transfer the metal to the reaction volume;
a heating element to heat the metal to a melting point of the metal to form the melted metal;
a steam inlet to introduce steam into the reaction volume to mix with the melted metal to form a metal oxide and H2, the steam formed by heating fuel cell exhaust water output by a hydrogen fuel cell (HFC) of the fuel cell electric vehicle;
an H2 outlet to output the H2 to an H2 storage container; and
a metal oxide outlet to output the metal oxide to a metal oxide storage container.

2. The H2 storage system of claim 1, wherein the metal is a metal powder, and
wherein the heating element is arranged to heat the metal powder during transfer of the metal powder from the metal storage container into the reaction volume.

3. The H2 storage system of claim 2, wherein the heating element is a resistive heating element.

4. The H2 storage system of claim 2, wherein the metal storage container further stores a pressurized gas at a storage pressure higher than a working pressure of the reaction volume to facilitate transfer of the metal powder toward the reaction volume.

5. The H2 storage system of claim 4, wherein the pressurized gas is not reactive with respect to the metal powder.

6. The H2 storage system of claim 1, wherein the metal storage container is replaceable.

7. The H2 storage system of claim 1, wherein the metal oxide storage container is replaceable.

8. The H2 storage system of claim 1, wherein the melted metal is at least one of aluminum, iron, and borium.

9. The H2 storage system of claim 1, further comprising a water storage container to receive the fuel cell exhaust water from the HFC and output the fuel cell exhaust water toward the steam inlet.

10. The H2 storage system of claim 9, further comprising a heating element disposed between the water storage container and the steam inlet to heat the fuel cell exhaust water to form the steam.

11. The H2 storage system of claim 10, wherein the heating element is a resistive heating element.

12. The H2 storage system of claim 1, wherein the H2 storage container is adapted to provide the H2 to the HFC.

13. A hydrogen (H2) storage system comprising:
an H2 storage container;
a hydrogen fuel cell (HFC) for receiving H2 from the H2 storage container and outputting exhaust water;
a metal storage container to store a metal powder;
a first heating element to heat the exhaust water to form steam;
a second heating element to heat the metal powder to form a melted metal; and
a reactor comprising:
a reaction volume;
a melted metal inlet to receive the melted metal into the reaction volume;
a steam inlet to receive the steam into the reaction volume, such that the melted metal and the steam mix to form a metal oxide and H2; and
an H2 outlet to output the H2 from the reaction volume to the H2 storage container.

14. The H2 storage system of claim 13, wherein the metal storage container further stores a pressurized gas at a storage pressure higher than a working pressure of the reaction volume to facilitate transfer of the metal powder from the metal storage container to the reaction volume, wherein the first heating element is arranged to heat the metal powder during the transfer of the metal powder from the metal storage container into the reaction volume.

15. The H2 storage system of claim 13, wherein the metal storage container is replaceable.

16. The H2 storage system of claim 13, further comprising a metal oxide storage container, wherein the reactor further comprises a metal oxide outlet to output the metal oxide from the reaction volume to the metal oxide storage container.

17. The H2 storage system of claim 16, wherein the metal oxide storage container is replaceable.

18. A method comprising:
transferring a metal powder from a metal storage container through a heating volume to form a melted metal;
transferring the melted metal into a reaction volume of a reactor of a fuel cell electric vehicle;
forming steam from fuel cell exhaust water output by a hydrogen fuel cell (HFC) of the fuel cell electric vehicle;
transferring the steam into the reaction volume to mix with the melted metal to form a metal oxide and H2;
outputting the H2 to an H2 storage container; and
outputting the metal oxide to a metal oxide storage container.

19. The method of claim 18, wherein the metal storage container is replaceable, and
wherein the metal oxide storage container is replaceable.

20. The method of claim 18, wherein the metal powder is at least one of aluminum, iron, and borium.
